(19) United States
(12) Patent Application Publication
(10) Pub. No.: US 2007/0205299 A1
(43) Pub. Date: Sep. 6, 2007

(54) Hot air heating system

(76) Inventor: Alvin Arnold, Martinsville, IN (US)

Correspondence Address: JAMES RAY & ASSOCIATES, 2640 PITCAIRN ROAD, MONROEVILLE, PA, 15146, US

(21) Appl. No.: 11/702,375

(22) Filed: Feb. 5, 2007

Related U.S. Application Data
(60) Provisional application No. 60/777,812, filed on Mar. 1, 2006.

(51) Int. Cl. F24B 7/00; F02M 35/02

(52) U.S. Cl. 237/55; 123/198 E; 123/41.7; 60/320

(57) ABSTRACT

An air heating system includes an internal combustion engine powered by combustible gas. Such engine having at least one cylinder and a horsepower determined by size of space to be heated. A source of such gas is in fluid communication with the engine for communicating a requisite amount of gas to such engine. An air intake is disposed in fluid communication with a source of air and the engine for communicating air to the engine. A flywheel is connected to the engine for at least extracting heat therefrom. An air chamber surrounds the engine for directing hot air extracted therefrom to such space to be heated. A heat exchanger is disposed in the air chamber for extracting heat from exhaust gases exiting the air chamber and heating air being returned to system. An exhaust is connected to the air chamber and to outside air for exhausting cooled air from system.

### CROSS REFERENCE TO RELATED APPLICATION

This patent application is related to and claims priority from U.S. Provisional Patent Application Ser. No. 60/777,812 filed Mar. 1, 2006.

### FIELD OF THE INVENTION

The present invention relates, in general, to hot air furnaces and, more particularly, this invention relates to a hot air heating system using an engines heat and exhaust to heat a predetermined space.

### BACKGROUND OF THE INVENTION

Prior to the conception and development of the present invention, as is generally well known in the prior art, hot air furnaces have been used in homes and industrial and/or commercial building for many years. Such hot air furnaces require electricity to operate the fan and gas burners for heating both the plenum on the furnace and the air coming into the furnace from the cold air return. These hot air type furnaces further require extensive controls to ensure the safety of the furnace. Furthermore, present day furnaces are not using as full an amount of oxygen as possible which cuts down on the BTU output of these furnaces.

As is well documented these hot air furnaces are not the most efficient users of the limited resources available today, either gas or electric. As everyone is aware it is becoming all the more important to conserve as many of these resources as possible.

### SUMMARY OF THE INVENTION

The present invention provides a hot air heating system which maximizes the use of oxygen as a means of increasing the thermal output of such hot air system. A hot air heating system which maximizes a use of oxygen in order to increase a thermal output of said hot air heating system. Such hot air heating system includes an internal combustion engine which is powered by a preselected gas. The internal combustion engine used will have a predetermined number of cylinders and a predetermined horsepower. Such number of cylinders and horsepower required will generally be determined by the size of the space to be heated. A source of such preselected gas is provided in the system. There is a first means disposed in fluid communication with the source of such preselected gas and with the internal combustion engine for communicating a requisite amount of such preselected gas from the source of such preselected gas to such internal combustion engine. Additionally, there is a means disposed in fluid communication with a source of air and with such internal combustion engine for communicating intake air from the source of air to such internal combustion engine. A flywheel is connected to such internal combustion engine for at least extracting heat from such internal combustion engine. An air chamber surrounds the internal combustion engine for directing hot air extracted from such internal combustion engine by such flywheel to such space to be heated. A heat exchanger is disposed in the air chamber for extracting additional heat from exhaust gases exiting such air chamber and heating air being returned to the hot air heating system. There is, also, an exhaust means connected to such air chamber and to the outside air for exhausting cooled air from such hot air heating system. Finally, a means is connected to such internal combustion engine for starting the hot air heating system.

### OBJECTS OF THE INVENTION

It is, therefore, one of the primary objects of the present invention to provide a hot air heating system which is a more efficient user of fuel than are present day hot air heating systems.

Another object of the present invention is to provide a hot air heating system which maximizes the use of oxygen to improve the efficiency of hot air heaters as compared to prior art type hot air furnaces.

Still another object of the present invention is to provide a hot air heating system which is relatively inexpensive to produce when compared to the present day hot air furnaces being used.

Yet another object of the present invention is to provide a hot air heating system which will help conserve the nations limited natural resources.

An additional object of the present invention is to provide a hot air heating system which will pay for itself due to the savings in energy usage.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a schematic illustration of a first embodiment of the hot air heating system constructed according to the present invention; and

FIG. 2 is a schematic illustration of an alternative presently preferred embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

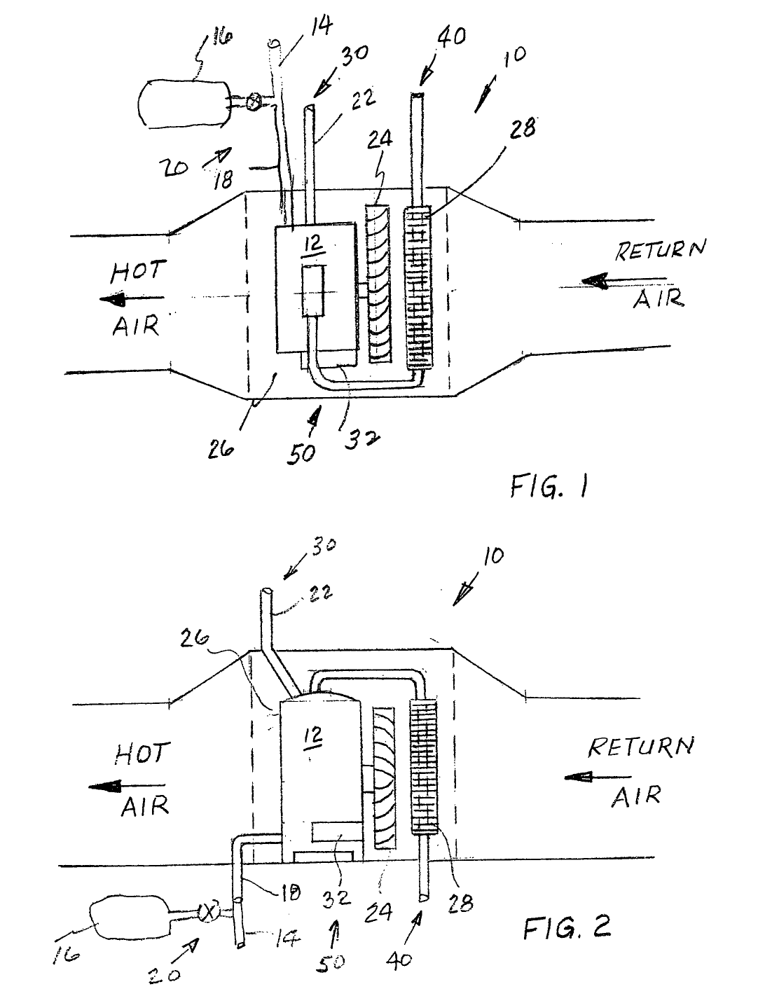

Refer now, more particularly, to FIGS. 1 and 2 of the drawings. Illustrated therein is a hot air heating system, generally designated 10, which maximizes a use of oxygen in order to increase a thermal output of such hot air heating system 10.

This hot air heating system 10 includes an internal combustion engine 12. The internal combustion engine 12 is powered by a preselected gas and has each of a predetermined number of cylinders and a predetermined horsepower. Such number of cylinders and horsepower will be determined by the size of the space (not shown) that is to be heated by the hot air heating system 10 of the present invention. In most cases, the number of cylinders required to provide adequate heat will only be a single cylinder. Such single cylinder internal combustion engine will be designed to operate at a speed of between about 1,200 RPMS to about 2,400 RPMS which should provide between about 100,000 BTU'S and about 200,000 BTU'S.

There is a source of such preselected gas provided. Preferably, such preselected gas will be selected from either natural gas and propane gas. The presently most preferred gas being natural gas and such source of such natural gas is a gas main 14. Alternatively, when such preselected gas is propane gas and then such source of propane gas will be a propane storage tank 16.

There is a first means, generally designated 20, disposed in fluid communication with each of such source 14 or 16 of the preselected gas and such internal combustion engine 12 for communicating a requisite amount of such preselected gas from the source 14 or 16 of such preselected gas to the internal combustion engine 12. In the presently preferred embodiment the first means 20 for communicating such preselected gas from the source 14 or 16 to the internal combustion engine 12 is a pipe member 18.

Hot air heating system 10 further includes a means, generally designated 30, disposed in fluid communication with each of a source of air and such internal combustion engine 12 for communicating intake air from the source of air to such internal combustion engine 12. Preferably, such means 30 for communicating intake air from the atmosphere to such internal combustion engine 12 is an air intake conduit 22.

A flywheel 24 is connected to such internal combustion engine 12 for at least extracting heat from the internal combustion engine 12. Such flywheel 24 acts as a fan in the hot air heating system 10 of the present invention.

In the presently preferred embodiment of the invention, there is an air chamber 26 which surrounds the internal combustion engine 12 for directing hot air extracted from such internal combustion engine 12 by the flywheel 24 to such space to be heated. Such air chamber 26 is formed as ductwork as is generally well known in the art.

According to the present invention there is a heat exchanger 28 disposed in such air chamber 26 for extracting additional heat from exhaust gases exiting such air chamber 26 and heating air being returned to the hot air heating system 10.

Additionally, there is an exhaust means, generally designated 40, connected to such air chamber 26 and to outside air for exhausting air cooled by the heat exchanger 28 from the hot air heating system 10. Preferably such exhaust means 40 is also ductwork.

Further the hot air heating system includes a means, generally designated 50, connected to such internal combustion engine for starting the hot air heating system 10. The presently preferred starting means 50 is an electric starter 32.

It should be recognized that other equipment can be utilized in the present invention such as a thermostat and various sensors to prevent overheating as are presently used in conventional heating systems. Additionally, it is within the scope of the present invention for the motor to be a combination motor electrical generator wherein the output can be wired to the heat panel to supply or add to the BTU output of the unit.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A hot air heating system which maximizes a use of oxygen in order to increase a thermal output of said hot air heating system, said hot air heating system comprising:
(a) an internal combustion engine powered by a preselected gas, said internal combustion engine having a predetermined number of cylinders and a predetermined horsepower, said number of cylinders and horsepower being determined by a size of a space to be heated;
(b) a source of said preselected gas;
(c) a means disposed in fluid communication with each of said source of said preselected gas and said internal combustion engine for communicating a requisite amount of said preselected gas from said source of said preselected gas to said internal combustion engine;
(d) means disposed in fluid communication with each of a source of air and said internal combustion engine for communicating intake air from said source of air to said internal combustion engine;
(e) a flywheel connected to said internal combustion engine for at least extracting heat from said internal combustion engine;
(f) an air chamber surrounding said internal combustion engine for directing hot air extracted from said internal combustion engine by said flywheel to such space to be heated;
(g) a heat exchanger disposed in said air chamber for extracting additional heat from exhaust gases exiting said air chamber and heating air being returned to said hot air heating system;
(h) exhaust means connected to said air chamber and to outside air for exhausting cooled air from said hot air heating system; and
(i) a means connected to said internal combustion engine for starting said hot air heating system.

2. A hot air heating system, according to claim 1, wherein said predetermined number of cylinders provided is a single cylinder.

3. A hot air heating system, according to claim 2, wherein said single cylinder internal combustion engine will be designed to operate at a speed of between about 1,200 RPMS to about 2,400 RPMS.

4. A hot air heating system, according to claim 3, wherein said single cylinder internal combustion engine will provide between about 100,000 BTU'S and about 200,000 BTU'S.

5. A hot air heating system, according to claim 1, wherein said preselected gas is selected from the group consisting of natural gas and propane gas.

6. A hot air heating system, according to claim 1, wherein said preselected gas is natural gas.

7. A hot air heating system, according to claim 6, wherein said source of said natural gas is a gas main.

8. A hot air heating system, according to claim 1, wherein said preselected gas is propane gas and said source of said propane gas is a propane storage tank.

9. A hot air heating system, according to claim 1, wherein said means for communicating said preselected gas from said source to said internal combustion engine is a pipe.

10. A hot air heating system, according to claim 1, wherein said means for communicating intake air from said source of air to such internal combustion engine is an air intake conduit.

11. A hot air heating system, according to claim 1, wherein said flywheel acts as a fan in said hot air heating system.

12. A hot air heating system, according to claim 1, wherein said air chamber is formed as ductwork.

13. A hot air heating system, according to claim 1, wherein said exhaust means is ductwork.

14. A hot air heating system, according to claim 1, wherein said system includes a motor generator.
